(19) United States
(12) Patent Application Publication
(10) Pub. No.: US 2004/0052355 A1
(43) Pub. Date: Mar. 18, 2004

(54) Apparatus, system and method of auto-completing telephone numbers that are being manually dialed

(75) Inventors: Faisal M. Awada, Round Rock, TX (US); Herman Rodriguez, Austin, TX (US); Newton James Smith JR., Austin, TX (US)

Correspondence Address: Mr. Volel Emile, P.O. Box 202170, Austin, TX, 78720-2170, US

(73) Assignee: International Business Machines Corporation, Armonk, NY

(21) Appl. No.: 10/242,526

(22) Filed: Sep. 12, 2002

(51) Int. Cl. H04M 1/00; H04M 3/00

(52) U.S. Cl. 379/355.01; 379/355.02

(57) ABSTRACT

An apparatus, system and method of auto-completing a pre-stored number being manually dialed by a user to make a phone call are provided. When a first digit of the number is entered, the digit is compared with first digits of pre-stored numbers to determine whether there is a match. If there is a match, the number whose digit matched the digit entered is provided to the user. The user may use the provided number to make the phone call or may continue to enter digits of the number. If there is not a match, the user will have to continue enter the number. When the number is used, it is automatically stored for future use. Instead of entering digits of a number, the user may enter letters of a name. As before, if the first letter entered matches a first letter of a pre-stored name, the name will be provided to the user. If the user indicates that the provided name is the desired name, a number associated with the name will be dialed to complete the phone call.

### BACKGROUND OF THE INVENTION

1. Technical Field

The present invention is directed generally to telephones. More specifically, the present invention is directed to an apparatus, method and system of auto-completing a telephone number that is being manually dialed.

2. Description of Related Art

Many conventional telephones incorporate an abbreviated dialing feature. Telephones, in this context, include cellular and mobile telephones, facsimile machines or any device a user may use to dial a telephone number. Abbreviated dialing features include speed dialing, redialing etc. Speed dialing requires that a telephone number be pre-stored in a memory device where it can be read out and dialed on request. For example, a user may program a telephone system so that pre-stored numbers are dialed with just a few keystrokes.

Redialing allows a user to redial the last number dialed with just a push of a button. This requires that when a number is dialed it be entered into a memory device. The memory device may be large enough to accommodate one telephone number. Thus, each time a succeeding number is dialed it replaces a previously dialed number in the memory device.

As can be surmised, an abbreviated dialing feature is designed to assist users in dialing telephone numbers. However, there may be instances when a user, for one reason or another, does not use the abbreviated dialing feature of a telephone system when dialing a number. When that occurs, the user has to dial the entire number manually even if the number is already stored in the telephone system.

Thus, there is a need for an apparatus, system and method of auto-completing a pre-stored number that is being dialed manually.

### SUMMARY OF THE INVENTION

The present invention provides an apparatus, system and method of auto-completing a pre-stored number that is being manually dialed. In an embodiment of the invention, when a first digit of the number is entered, the digit is compared with first digits of pre-stored numbers to determine whether there is a match. If there is a match, the number whose digit matched the digit entered is provided to the user. The user may use the provided number to make a phone call or may continue to enter digits of the number. If the user enters a next digit and if there were multiple numbers with the first digit, another number from the group of numbers that has the first digit entered by the user will be provided if its second digit matched the second digit entered. This will continue until the user either indicates that the number provided is the desired number or dials the entire number manually. If the pre-stored numbers do not have any one of the digits entered, the user will have to finish dialing the number manually. When the number is used, it is automatically stored in a list for future use.

In another embodiment of the invention, letters of a name are entered instead of digits of a number. As before, if the first letter entered matches a first letter of a pre-stored name, the name will be provided to the user. If the user indicates that the name is the desired name, a number associated with the name will be dialed to complete the phone call. If the user enters another letter, another search is performed to determine whether any one of the pre-stored names that have the first entered letter also has the second letter etc. If the pre-stored names do not have any one of the letters entered by the user, then, the user has to dial in the number of the person manually.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a schematic block diagram of a telephone apparatus.

FIG. 2 depicts an operating panel used by the present invention.

FIG. 3 depicts a phone book used by the present invention.

FIG. 4 is a flow chart of a process that may be used to implement the invention.

FIG. 5 is a state diagram that may be used in implementing the invention.

FIG. 6 is a flow chart of a process that may be used by a telephone service provider to implement the invention.

### DETAILED DESCRIPTION OF THE PREFERRED EMBODIMENT

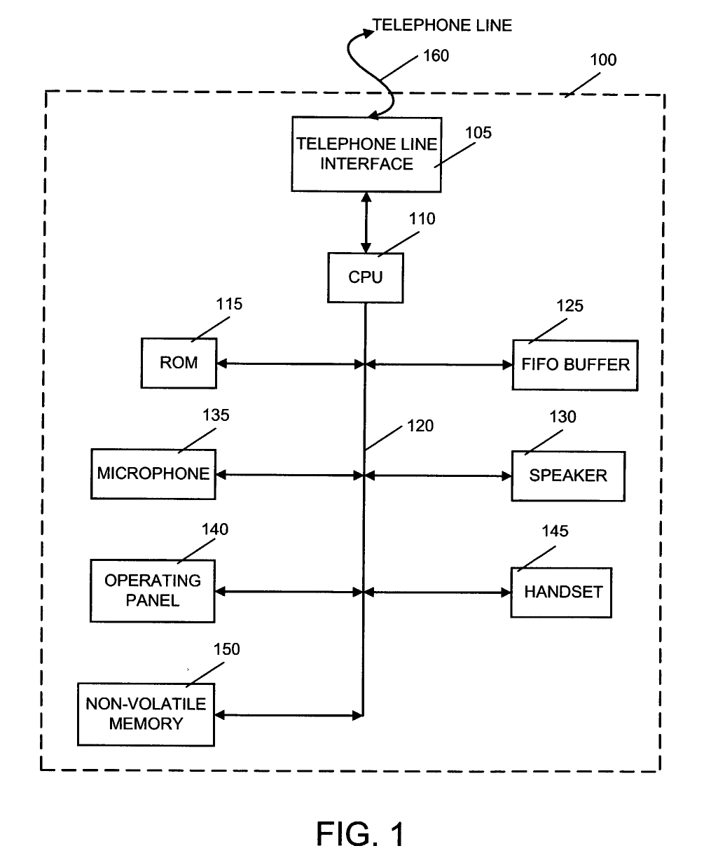

Turning to the figures, FIG. 1 depicts a schematic block diagram of a telephone apparatus 100. The telephone apparatus 100 is connected to a telephone line 160 through a telephone line interface 105. The telephone line 160 may be an antenna for those devices that are not land-line connected to a telephone service provider. The telephone line interface 105 is connected to CPU 110. CPU 110 is connected to ROM 115, first-in, first-out (FIFO) buffer 125, speaker 130, microphone 135, operating panel 140, handset 145 and non-volatile memory 150 via a bus 120.

With the use of a software utility package stored in ROM 115, CPU 110 performs various functions. For example, the CPU 110 may send a ring tone to speaker 130 whenever the telephone line interface 105 detects a ring signal. Likewise, CPU 110 may send a busy tone to speaker 130 when the telephone line interface 105 detects a busy signal.

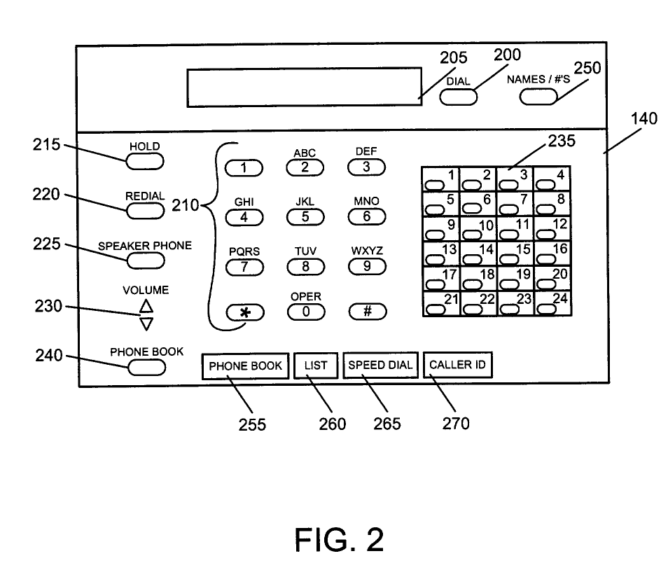

When CPU 110 detects that a user wants to make a phone call, it sends a dial tone to handset 145. Likewise, when CPU 110 detects that a speaker phone button (see FIG. 2) has been depressed, it also sends a dial tone to speaker 130. Microphone 135 allows a user to communicate with a person on the telephone without using the handset 145. Non-volatile memory 150 is used to store a phone book, a list of recently dialed numbers as well as pre-programmed numbers for speed dialing and FIFO buffer 125 is used to store the most recently dialed number for the redial feature.

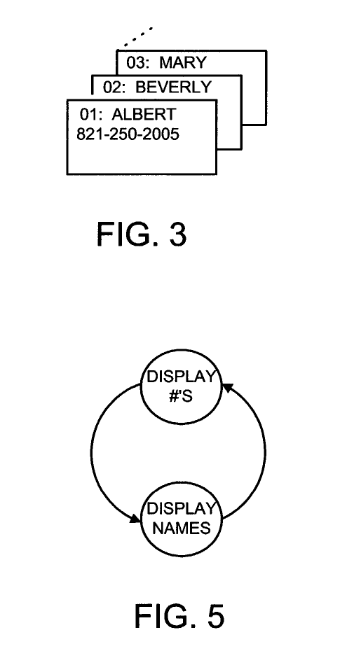

FIG. 2 depicts the operating panel 140. For a better understanding of the invention, FIG. 2 should be viewed in conjunction with FIG. 1. The operating panel 140 contains hold button 215 that is used to put a person with whom the user is communicating on hold. Redial button 220 allows the user to redial a number that was previously dialed. Speaker phone button 225 in conjunction with microphone 135 allows the user to use the phone without the handset 145. Volume 230 allows a user to increase or decrease the volume of the sound from the speaker 130. Phone book button 240 allows access to telephone numbers that have been stored into non-volatile memory 150. FIG. 3 depicts an example of a phone book.

Speed dial pad 235 contains buttons 1, 2, 3 etc. that may be depressed to dial pre-programmed numbers. Dial pad 210 allows a user to dial numbers as well as to fill in the phone book 240 and pre-program numbers for speed dialing. Display 205 may be a liquid crystal display (LCD) on which numbers that are being dialed may be displayed. If there is a number or a name displayed on LCD 205 and dial button 200 is depressed, the displayed number or the number associated with the name displayed will be dialed.

The method of speed dialing, redialing, entering numbers in phone books, retrieving numbers from phone books, using the speaker phone etc. is well known in the field and will not be further described. Thus, the rest of this disclosure will focus on the present invention.

The invention is a method of auto-completing phone numbers as they are being dialed. When a user begins to dial a phone number or enter a name, the auto-complete feature consults the list of recently dialed numbers, the phone book, the pre-programmed numbers used in speed dialing or a combination thereof to display a number or name on LCD 205. With each digit or letter entered, a different number or name may be displayed. If the displayed number or name is the desired number or name, the user may depress dial button 200 to complete dialing the number. If the number or name displayed is not the desired number or name, the user may continue to enter digits or letters. The user may do so until the entire number or name is either completed automatically from the pre-stored numbers or names or entered manually. In the case where a name is being entered, if the name is not already stored in the telephone associated with a number, the user will have to revert to dialing the number associated with the name.

When a call connection is completed, the number dialed may be entered into the list of recently dialed numbers for future use. Note that unless there are numbers associated with names in the list of most recently dialed numbers, the auto-complete feature may not work with the list when letters of a name are being entered. Names may be associated with numbers in the list of recently dialed numbers if the number and associated name were already stored in the telephone. For example, a number dialed using speed dialing or the phone book may have a name associated with it. In that case, the number including its associated name will be entered in the list of recently dialed numbers.

Furthermore, if the telephone has an integrated caller identification (caller ID) feature, it may store numbers associated with names of incoming calls. These numbers and associated names may be available to the auto-complete feature of the invention. Thus, the invention may be designed such that whenever a name or number is being dialed, all available storage systems where numbers and/or names are stored are searched in an attempt to auto-complete the number or name.

Function button 250 may be used to configure the auto-complete feature to display either phone numbers or names on the LCD 205. Each time it is depressed, it changes state as shown in FIG. 5. For example, if the function button 250 is in state 1, the LCD 205 displays numbers. If it is depressed while in that state, it will move to state 2 where names will be displayed on the LCD 205. If depressed once more, it will return to state 1 where numbers will again be displayed.

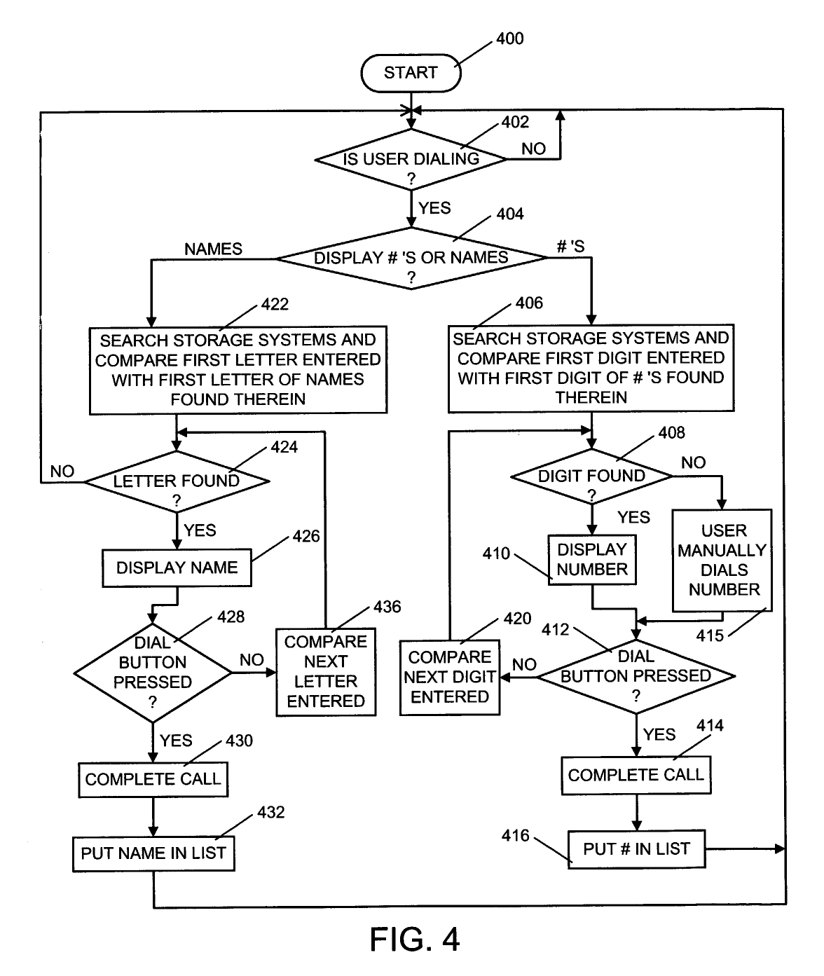

FIG. 4 is a flow chart of a process that may be used to implement the invention. The process may be stored in ROM 115 or any other devices used to store numbers and/or names. The process starts whenever the telephone is plugged in or is activated (step 400). A check is continuously being made to determine whether a user is entering digits or letters to dial a number. If so, another check is made to determine whether the LCD 205 is configured to display names or numbers. If numbers are to be displayed, the storage devices in which phone numbers are stored (e.g., storage devices containing numbers in the phone book, list of recently used numbers, caller ID numbers, numbers preprogrammed for the speed dialing feature, etc.) are searched in order to compare the first digit entered with the first digit in the numbers in the storage devices. If the digit is found, the first number (in a numerical order) that contains the same digit as the one entered is displayed on LCD 205. If the dial button 200 is depressed, then the invention completes dialing the number. The number and associated name if it exists may be entered in the list of recently dialed numbers and the process ends by returning to step 402. If dial button 200 is not depressed, the next digit entered is compared with the next digit of the stored numbers that contain the previous digit and the process returns to step 408 (steps 402-416).

If an entered digit is not found in any of the stored numbers, then the invention will not provide a number to the user. The user will then have to enter all the digits in the number manually to complete dialing the number. Once done, the dialed number may be placed in the list of recently dialed numbers and the process ends by returning to step 402 (steps 408 and 416).

If the LCD 205 is set to display names, the storage devices are searched in order to compare the first letter entered with the first letter in the stored names. If the letter is found, the first name (in an alphabetical order) that contains the same letter as the one entered is displayed on LCD 205. If the dial button 200 is depressed, then the invention automatically dials the associated number. The name and associated number may then be entered in the list of most recently dialed numbers. The process ends by returning to step 402. If dial button 200 is not depressed, the next letter entered is compared with the next letter of the stored names that contain the previous entered letter and the process returns to step 424 (steps 402, 404, 422-432).

If an entered letter is not found in any of the stored names, then a name will not be provided. The user will then have to switch the function of the LCD 205 to display numbers in order to enter digits instead of letters. Once done, the process will start all over again at step 402.

Note that, if a certain amount of time has elapsed without any input from the user, the invention may time out. If the invention times out, the user will have to start the process all over again in order to place a phone call. Note further that before storing the number and associated name in the list, a search may be performed to determine whether they are already in the list. If so, the number and associated name are not stored in the list; otherwise, they are. Alternatively, the number and name may be stored regardless of whether or not they are already in the list. This may be done to provide attributes of the calls (e.g., call time, duration etc.).

In the above description, the default option of searching all storage devices where numbers and/or names are stored is used. However, the invention may be configured such that a particular storage device is searched to auto-complete a call. For example, if phone book option button 255 is depressed, only the numbers and names in the phone book will be searched to auto-complete the call. Likewise, if list option button 260, speed dial option button 265 or caller ID option button 270 is depressed, only the list of recently dialed numbers and their associated names, the preprogrammed numbers and names stored therein or the numbers and names in the caller ID memory device, respectively, will be searched. If other lists of numbers and names are to be searched, additional option buttons may be added on the operating panel 140 to instruct the invention to search the option button depressed. When any one of the option buttons is depressed, a pointer is positioned at the location in memory where the numbers or names for that particular option are stored.

If a user has a telephone that does not incorporate the auto-complete feature, the user may subscribe to a telephone service provider that provides the feature. In that case, the service provider may store all telephone numbers that the user has previously called. When the user is entering digits of a number previously called, the service provider may detect the digits entered and provide numbers in a numerical order to the user. The telephone in use may have an LCD to display the numbers provided or an LCD of a standalone caller ID device may be used. Alternatively, the number may be provided by voice. If the user depresses a dial button or talk button on the telephone when a number is provided, the call will be completed using the number.

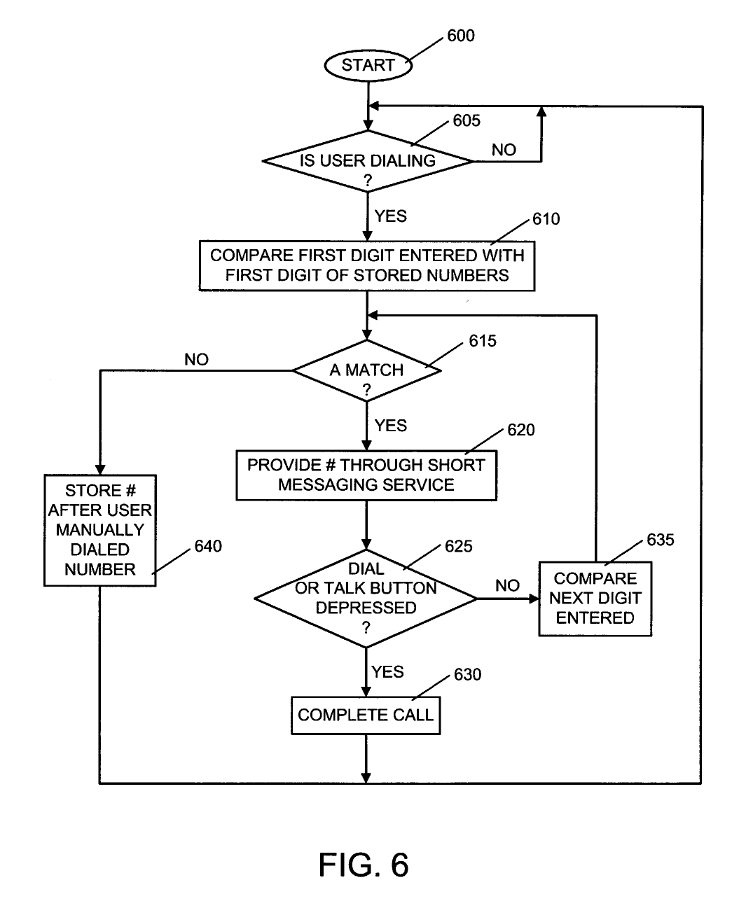

FIG. 6 is a flow chart of a process that may be used by a telephone service provider to implement the invention. The process starts when the service is activated (step 600). A test is continuously being made to determine whether a subscribed user is dialing a number. If so, the first digit entered is compared with the first digit of the stored numbers for that particular user. If there is a match, the first number, in a numerical order if there is more than one match, is provided. The number may be provided using a short messaging service or equivalent. The provided number may be displayed on an LCD on the telephone itself or on a device that has an LCD that the service provider may have provided to the user. In any case, if the user indicates that the call should be completed with the provided number, the call is completed and the process ends by returning to step 605 (steps 605-630). If the user does not so indicate, the next digit entered will be compared with the next digit of the stored numbers that also had a matched first digit and the process returns to step 615 (step 635). If there is not a match with any one of the digits entered, the user will have to manually dial the number. Then, the number dialed will be stored for future use and the process returns to step 605 (steps 615 and 640).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of auto-completing a telephone number being dialed by a user comprising the steps of:
comparing a first digit entered by the user with first digits of pre-stored numbers to determine if there is a match; and
providing to the user, if there is a match, a number that has the matched digit.

2. The method of claim 1 wherein if there is more than one pre-stored number with the matched digit, the first number in a numerical order is provided to the user.

3. The method of claim 2 wherein if there is a match and the user enters a succeeding digit, the succeeding digit is compared with the succeeding digit of the numbers that have a match with a previously entered digit to determine if there is a match.

4. The method of claim 3 wherein if there is a match the first number, in a numerical order, that has the matched digit is provided to the user.

5. The method of claim 4 wherein if the user indicates that a provided number is the number being dialed, the number is used.

6. The method of claim 5 wherein the numbers are stored in a telephone.

7. The method of claim 5 wherein the numbers are stored by a telephone service provider, the telephone service provider providing the number with matched digits to the user.

8. The method of claim 5 wherein the numbers are stored in a facsimile machine.

9. The method of claim 1 wherein letters of a name are entered instead of digits of a number, a first letter entered is compared with first letters of pre-stored names to determine if there is match and a pre-stored name is provided to the user if there is a match.

10. A computer program product on a computer readable medium for auto-completing a telephone number being dialed by a user comprising:
code means for comparing a first digit entered by the user with first digits of pre-stored numbers to determine if there is a match; and
code means for providing to the user, if there is a match, a number that has the matched digit.

11. The computer program product of claim 10 wherein if there is more than one pre-stored number with the matched digit, the first number in a numerical order is provided to the user.

12. The computer program product of claim 11 wherein if there is a match and the user enters a succeeding digit, the succeeding digit is compared with the succeeding digit of the numbers that have a match with a previously entered digit to determine if there is a match.

13. The computer program product of claim 12 wherein if there is a match the first number, in a numerical order, that has the matched digit is provided to the user.

14. The computer program product of claim 13 wherein if the user indicates that a provided number is the number being dialed, the number is used.

15. The computer program product of claim 14 wherein the numbers are stored by a telephone service provider, the telephone service provider providing the number with matched digits to the user.

16. A system for auto-completing a telephone number being dialed by a user comprising:
at least one storage device for storing code data; and
at least one processor for processing the code data to compare a first digit entered by the user with first digits of pre-stored numbers to determine if there is a match, and to provide to the user, if there is a match, a number that has the matched digit.

17. The system of claim 16 wherein if there is more than one pre-stored number with the matched digit, the first number in a numerical order is provided to the user.

18. The system of claim 17 wherein if there is a match and the user enters a succeeding digit, the succeeding digit is compared with the succeeding digit of the numbers that have a match with a previously entered digit to determine if there is a match.

19. The system of claim 18 wherein if there is a match the first number, in a numerical order, that has the matched digit is provided to the user.

20. The system of claim 19 wherein if the user indicates that a provided number is the number being dialed, the number is used.
